(19) United States
(12) Patent Application Publication
(10) Pub. No.: US 2012/0067325 A1
(43) Pub. Date: Mar. 22, 2012

(54) METHOD FOR OPERATING AN INTERNAL COMBUSTION ENGINE AND INTERNAL COMBUSTION ENGINE IN ACCORDANCE WITH SAID METHOD

(76) Inventors: Patrick Wathieu, Herrlisheim (FR); Michele Wathieu, Herrlisheim (FR)

(21) Appl. No.: 13/321,019

(22) PCT Filed: May 26, 2010
(86) PCT No.: PCT/IB2010/001242

§ 371 Date: Nov. 17, 2011

(30) Foreign Application Priority Data
May 26, 2009 (FR) 09/53465

(51) Int. Cl. F02B 47/02

(52) U.S. Cl. 123/25 C

(57) ABSTRACT

A reciprocating internal combustion engine (10) which comprises a tank (23), at least one cylinder (11), a piston (12) that can perform an axial reciprocating movement housed within this cylinder, this piston including a head and an arm hinged to this head, and at least one intake valve (19) and one exhaust valve (20) provided on the cylinder above said piston (12) and above two injectors (21a and 21b). The engine (10) is equipped with a device (27) for producing, by electrolysis of water, gaseous dihydrogen that is fed in the cylinder (11) and an explosion starts moving the piston (12) beyond a top dead center (TDC). A predetermined volume of water is then injected and instantaneously vaporized by the heat produced by the explosion of the gaseous dihydrogen. The hot steam pushes the piston (12) towards the bottom dead center (BDC) where the steam is then discharged through the exhaust valve (20). This engine only produces steam and thus is clean.

This application is a national stage completion of PCT/IB2010/001242 filed May 26, 2010 which claims priority from French application Ser. No. 09/53465 filed May 26, 2009.

### TECHNICAL SCOPE

The invention relates to a method for operating a reciprocating internal combustion engine comprising a water tank, at least one cylinder, a piston that can perform an axial reciprocating movement housed inside this cylinder, this piston including a head and an arm hinged to this head, and at least one intake valve and one exhaust valve provided on the cylinder above said piston, method using gaseous dihydrogen.

It also relates to a reciprocating internal combustion engine comprising a water tank, at least one cylinder, a piston that can perform an axial reciprocating movement housed inside this cylinder, this piston including a head and an arm hinged to this head, at least one intake valve and at least one exhaust valve provided on the cylinder above said piston.

### PRIOR TECHNIQUE

There are many engine types based on the combustion of a fuel, in particular of a fossil fuel. The operating principle of these engines is well known, even though important improvements aiming to increase the efficiency, decrease the consumption and reduce pollution have been made during these last years and still remain to be made. It is moreover known that many natural energy sources, and mainly the fossil fuel reserves, are becoming scarce. Furthermore, agriculture, whose products could allow generating oils or ethanols, in particular from rapeseed and sugar cane, must first of all allow feeding the human and animal population. The agricultural resources are no more sufficient today to achieve these goals.

It is thus advantageous to look for sources of energy that both are abundant and have the advantage of being renewable to provide for the constantly increasing needs. The sun and the wind are already widely used to produce electrical energy, but there is the problem of storing this energy, which reduces the scope of its use.

Freshwater may represent an appealing solution, but the global warming shows that this resource also may become scarce, since it is absolutely indispensable to provide for the needs of the human population, of animal life and of vegetal life.

On the other hand, sea water represents 70% of the surface of the earth and regenerates with rain and ice melt. Using sea water as a source of energy may represent an interesting alternative for the current sources of energy, provided a simple, cost-effective and efficient means is set up for exploiting it with a view to energy production.

The current reciprocating engine, powered by fossil fuels or synthetic fuels, either two or four-stroke, still represents today one of the most efficient ways to produce mechanical energy that can be directly used for ensuring all drive, propulsion, traction or similar functions immediately exploitable. Indeed, the pressure exerted by a detonation on the head of a piston of an engine of this type is approximately perpendicular to its surface and causes its displacement, generating the rotational movement of an output shaft of this engine. Even though the rotary devices such as the Wankel engine and the quasiturbine have been developed to avoid the obligation of converting a reciprocating movement into a rotating movement, the angle with which the pressure of the explosion or of the expansion is exerted is less favorable than on a reciprocating engine. One will note that the quasiturbine offers a slightly better angle than that of the Wankel process.

One of the main drawbacks of the current reciprocating engine is due to the fact that the explosion which generates an intense release of energy takes place while the piston is at the top dead centre (TDC). At this moment, the lever arm defined by the angle of the rod and the centre of the crankshaft is the smallest.

In order to have ideal conditions, the explosion in the reciprocating engine should take place while the rod is horizontal with respect to the axis of the crankshaft, that is to say, when the lever arm is also at its maximum. Certain systems, such as the gun engine, suggest postponing the explosion so that its maximum effects take place when the piston of the corresponding reciprocating engine has passed its top dead centre (TDC) by several tens of degrees.

It results from this that the current explosion engines, which use fossil or similar fuels, even though they are relatively efficient, do not allow producing mechanical energy in optimal conditions. Furthermore, the use of fossil fuels, which are in the process of depletion, is deemed to stop in a relatively close future. Finally, the use of fossil fuels is polluting, since it releases enormous quantities of carbon dioxide and unburnt particles, which are partly responsible of the climatic warming and the pollution of our atmosphere.

### DESCRIPTION OF THE INVENTION

This invention offers an alternative that aims to eliminate the pollution due to the exhaust gases usually produced by the current heat engines, by proposing an internal combustion engine whose operation is optimized in such a way that the energy produced during the operating cycle is best used to generate mechanical forces, while eliminating the use of fossil fuels, which are difficult and dangerous to extract, and using substances that are indefinitely renewable on the planet.

To that purpose, the method according to the invention is characterized in that it includes the following steps:

a.—a first step, during which a predetermined volume of gaseous dihydrogen and a predetermined volume of a gaseous mix containing oxygen are fed into a space of said cylinder located above the head of said piston,

b.—a second step, during which the gaseous dihydrogen fed into the cylinder is made to explode at the moment when the piston has passed the top dead centre (TDC),

c.—at least one third step, during which a predetermined volume of water is injected in said cylinder, in a space located above said piston, to vaporize instantaneously this water under the influence of the heat produced by the explosion of the gaseous dihydrogen and to cool down the engine, and

d.—a fourth step, during which the steam produced by the evaporation of the injected water and the combustion of the gaseous dihydrogen is exhausted.

Advantageously, the method includes a preliminary step, during which, by electrolysis of the water of said tank, gaseous dihydrogen is produced, of which at least a predetermined volume is taken during said first operating step of the engine.

During said preliminary step, salt water contained in the tank is used preferably for producing gaseous dihydrogen by electrolysis and cooling down the engine.

Said first, second and third steps of the operation take place preferably while said piston passes from the top dead centre (TDC) to the bottom dead centre (BDC), while said fourth step of the operation takes place while said piston passes from the bottom dead centre (BDC) to the top dead centre (TDC).

In a particularly advantageous way, said engine comprises several cylinders, each including a piston housed in one of said cylinders, and the whole of the first, second, third and fourth steps are performed individually in each of the cylinders of said engine, each of said steps performed in one of the cylinders being shifted in time with respect to the corresponding step performed in another of said cylinders of said engine.

Also to that purpose, the internal combustion engine according to the invention, as defined in the preamble, is characterized in that it includes:

a.—means for feeding, during a first step, a predetermined volume of gaseous dihydrogen and a predetermined volume of a gaseous mix containing oxygen into said cylinder, into a space located above the head of said piston,

b.—means for producing, during a second step, the explosion of the mix of gaseous dihydrogen and oxygen fed into the cylinder, at the moment when the piston has passed the top dead centre (TDC),

c.—means for injecting, during at least one third step, a predetermined volume of water into said cylinder, into a space located above said piston, to vaporize instantaneously this water under the influence of the heat produced by the explosion of the gaseous dihydrogen and the oxygen and to cool down the engine, and

d.—means for exhausting, during a fourth step, the steam produced by the evaporation of the injected water and the combustion of the gaseous dihydrogen.

The engine comprises preferably means for producing gaseous dihydrogen through the electrolysis of the water contained in said tank.

In an embodiment variant, the production of the gaseous dihydrogen may include means for performing high-temperature electrolysis.

Preferentially, said tank contains salt water for producing gaseous dihydrogen by electrolysis.

According to an advantageous embodiment, said means for feeding a predetermined volume of gaseous dihydrogen during a first step comprise an injector.

In addition, said means for feeding a predetermined volume of a gaseous mix containing oxygen during a first step comprise an intake valve.

The means for injecting a predetermined volume of water of said tank into said cylinder may comprise an injector associated with an injection pump.

In the case of an engine with several cylinders, each comprising a piston housed in one of these cylinders, it includes advantageously control means so that, in each of the cylinders, the steps corresponding to one of the cylinders are shifted in time with respect to the corresponding steps in each of the other cylinders.

### BRIEF DESCRIPTION OF THE DRAWINGS

The present invention and its advantages will be better revealed in the following description of an embodiment given as a non limiting example, in reference to the drawings in appendix, in which:

FIG. 1 represents a view showing the principle of the engine according to the invention,

FIG. 2 is a view illustrating a first phase of the operating cycle of the engine of FIG. 1,

FIG. 3 is a view illustrating a second phase of the operating cycle of the engine of FIG. 1,

FIG. 4 is a view illustrating a third phase of the operating cycle of the engine of FIG. 1, and

FIG. 5 is a view illustrating a fourth phase of the operating cycle of the engine of FIG. 1.

### BEST WAY OF REALIZING THE INVENTION

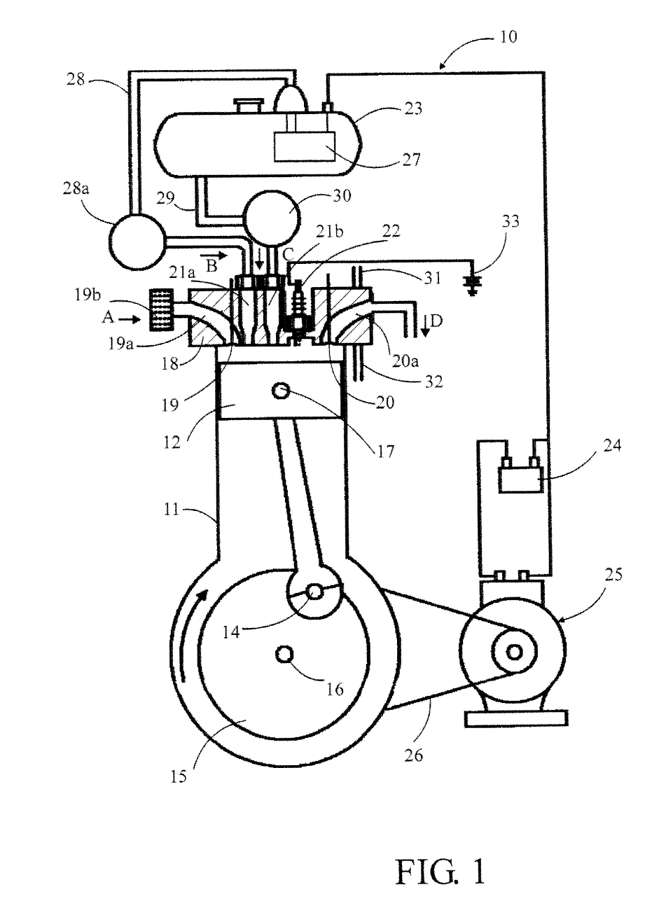

Referring to FIG. 1, the internal combustion engine 10, as it is represented schematically in a first simplified version, includes one single cylinder 11 in which a piston 12 having a reciprocating linear movement is housed, attached to a rod 13 mounted rotatably at one of its ends 14 on a rotary flywheel 15 mounted on a central shaft 16, this rod 13 being furthermore hinged at its opposite end 17 on piston 12. Above the cylinder 11, the engine block 10 comprises a cylinder head 18 in which are housed, in particular, an intake valve 19, an exhaust valve 20, a first injector 21a, a second injector 21b and a spark plug 22, or similar, whose functions will be defined later. The intake valve 19 is mounted in the cylinder head 18 at the end of an intake piping 19a on which an air filter 19b is mounted.

The engine 10 is associated with a water tank 23, for example salt water, with an accumulator battery 24 and an alternator 25, driven by flywheel 15, for example via a belt 26, for recharging the accumulators 24. In the example of embodiment described, the tank 23 contains an electrolysis device 27, arranged to produce gaseous dihydrogen by electrolysis of the salt water contained in tank 23. Obviously, this electrolysis device 27 could be located also outside of tank 23. The electrolysis device 27 is connected, via a dihydrogen supply circuit 28 with injector 21a, through an injection pump 28a mounted on the supply circuit 28. The tank 23 is also connected, via a water supply circuit 29, to an injection pump 30 coupled with injector 21b arranged to inject pressurized water into the space defined by the top of piston 12 and the top of cylinder 11.

During operation, a small quantity of gaseous dihydrogen is produced by electrolysis, preferably during a preliminary step, and the engine 10 is fed during a first step by injecting a predetermined volume of this gas through the supply circuit 28 connected with injector 21a. The dihydrogen is used as fuel and air or oxygen is added as oxidant via the intake piping 19a ending in the space defined by the top of piston 12 and the top of cylinder 11, through the intake valve 19. During another operating step, liquid salted water is injected via the supply circuit 29 connecting the bottom of tank 23 to injector 21b through injection pump 30.

As a variant, the gaseous dihydrogen required for the operation of engine 10 may be produced according to a high-temperature electrolysis process, which requires an auxiliary water circulation device. This equipment, which implies means for vaporizing the water coming from tank 23, is represented by pipes 31 and 32 ending in cylinder head 18.

The classical spark plug 22, used in the internal combustion engines, which requires usually a coil-contact breaker set, may be replaced in the present case with a piezo-electric system, which has the advantage of low electrical power consumption. This supply is represented schematically under item 33. This solution can be used because the explosion of the hydrogen requires only a very low energy for taking place.

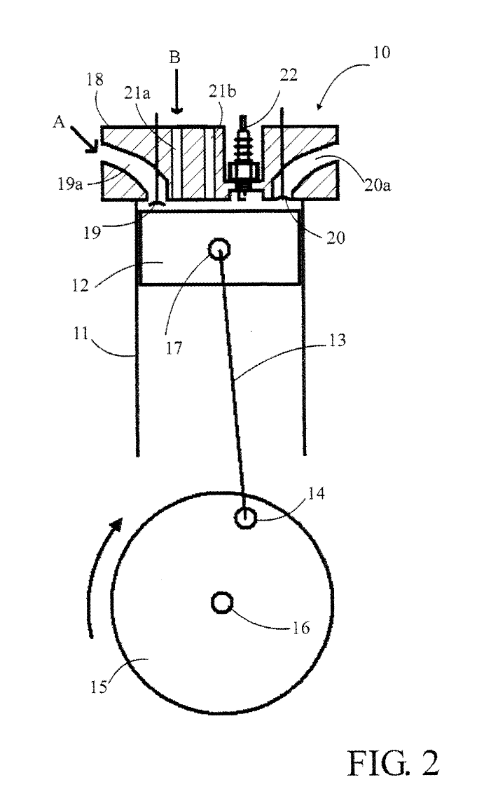

The operating steps of the engine will be described more in detail with reference to FIGS. 2 to 5, which illustrate the principles of the method according to the invention. FIG. 2 illustrates a first step during which a volume of air is drawn in at the top (on the figure) of cylinder 11 as shown by arrow A, this aspiration being due to the depression produced in cylinder 11 when the piston 12 moves down. In a slightly shifted way, a predetermined volume of gaseous dihydrogen produced by electrolysis during a preliminary step is injected at the top (on the figure) of cylinder 11 through injector 21a, as shown by arrow B. Thus, the space between the top of piston 12 and the top of cylinder 11 is filled with an explosive mix of gaseous dihydrogen and air.

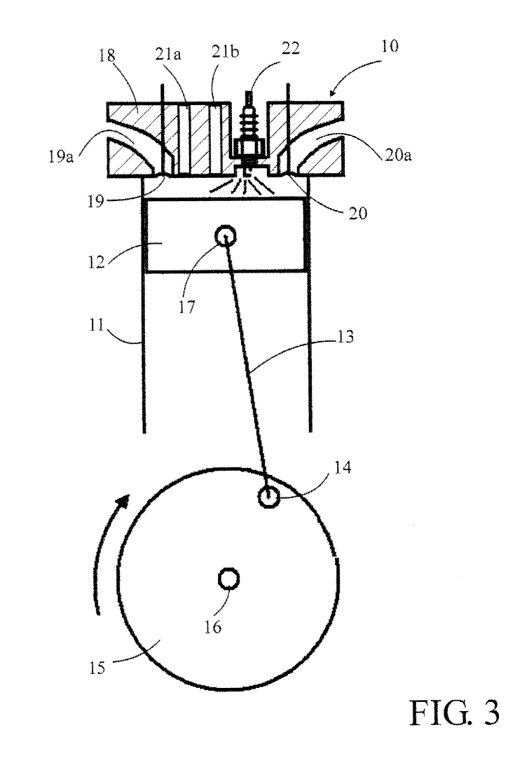

FIG. 3 illustrates the second step, during which the explosion of the mix of gaseous dihydrogen and air is triggered off by means of a spark produced by spark plus 22. This explosion has the effect of generating a pushing force on piston 12, causing its displacement downwards (on the figure), actuating flywheel 15 thanks to the coupling of piston 12 and flywheel 15 by rod 13.

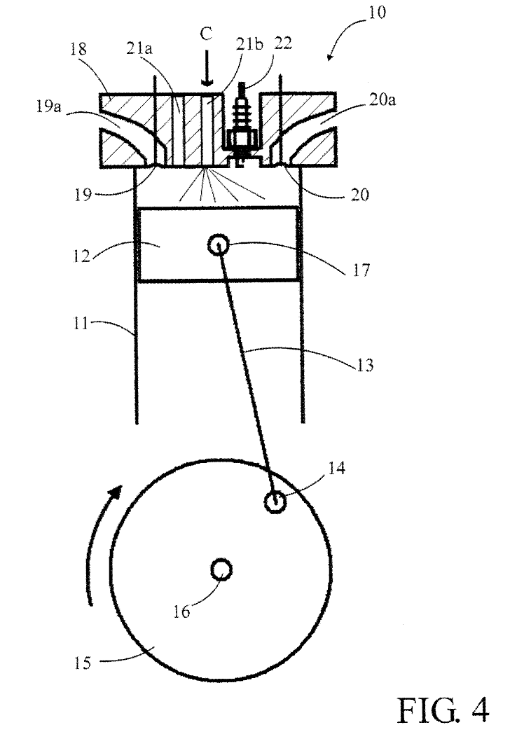

The following step, illustrated by FIG. 4, consists in injecting, through injector 21b, a certain quantity of water taken from tank 23 into the space located between piston 12 and the top of cylinder 11. The feeding by injector 21b is represented schematically by arrow C. Since this space has been carried to a very high temperature during the previous step by the explosion of the gaseous mix, the injected water vaporizes instantaneously, becoming very high-pressure steam. This pressure contributes to pushing piston 12 downwards (on the figure) in the cylinder and generating a high driving torque of flywheel 15.

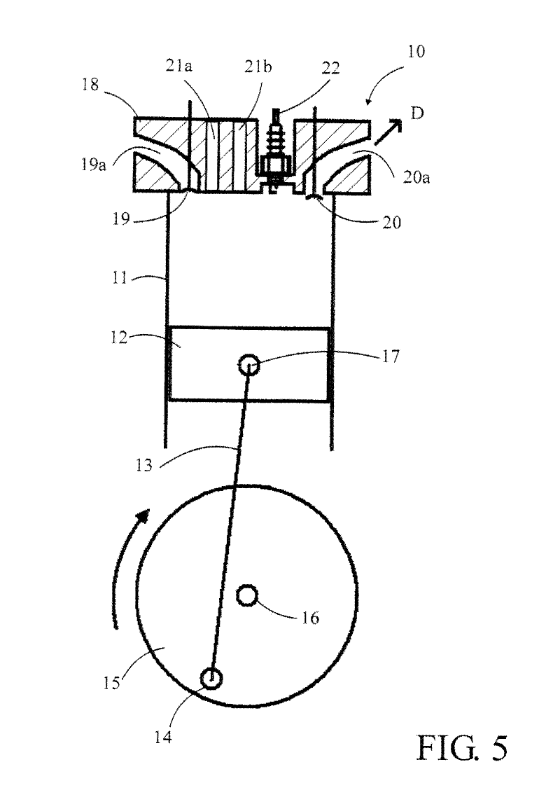

Thanks to the combined thrusts due to the explosion of the mix of gaseous dihydrogen and air or oxygen, combined with the expansion of the steam produced in cylinder 11, the flywheel 15 rotates, driving piston 12 first from the top dead centre (TDC) to the bottom dead centre (BDC), then beyond the bottom dead centre (BDC). A step for exhausting the gases contained in cylinder 11 starts while piston 12 “rises”. This step is represented by FIG. 5. The exhaust gases are exhausted through the exhaust valve 20 and the exhaust piping 20a, as shown by arrow D.

One will note that the engine 10 is of the two-stroke type, which makes it particularly efficient since, to every active step corresponding to the down move of piston 12 as a result of a thrust exerted on the head of said piston 12, corresponds only one reactive phase corresponding to the up move of piston 12 and to the exhaust of the gases.

Water electrolysis, in particular salt water and for example sea water, is used for generating a small volume of gaseous dihydrogen, since the greatest part of the pushing force is produced by the instantaneous vaporization of the water injected into the cylinder. Hence, an electrical generator, for example an alternator, of small dimensions is sufficient for producing the required electrical energy. In addition, the injection of the water has the secondary effect of cooling down the cylinder 11, avoiding thus injecting the gaseous dihydrogen at a temperature exceeding its self-ignition temperature, which is of the order of 550° C. Since the temperature reached at the moment of the explosion of the gaseous mix is very high, one single water injection may not be sufficient to cool down the engine appropriately. In this case, a second, or even more cycles could be performed without explosion of the explosive gaseous mix, and the engine could operate as a simple steam engine. The steam is generated by the residual heat of the explosion of the gaseous mix and the controlled injection of water at the top of the cylinder at each beginning of a cycle. To that purpose, suitable temperature and pressure sensors are arranged to supply the information to a central control unit, which drives the injectors and the valves.

Even though the engine 10 described comprises one single cylinder 11, the internal combustion engine of the invention may be provided with several cylinders mounted in parallel and having similar operating modes. In this case, the engine 10 would be provided with a crankshaft coupled with the different rods of the different pistons. The operating phases of each of the pistons, of each of the cylinders, are identical in this case. However, the different pistons are shifted with respect to each other and the operating steps are also shifted, in order to optimize the torques exerted on the crankshaft.

Furthermore, the engine 10 as it is described may undergo various modifications and appear in various variants covered by the invention. One of the fundamental advantages of the engine of the invention lies in the fact that the gaseous dihydrogen, whose storage is usually considered as hazardous, is consumed directly at the moment of its production, which eliminates totally the risks inherent to the storage. The volume produced during the preliminary steps is practically consumed during the first steps of each operating cycle of the engine. The exhaust gases produced are steam and air. The operation is economical and non-polluting.

1-14. (canceled)

15. A method of operating a reciprocating internal combustion engine (10) comprising:
a water tank (23),
at least one cylinder (11),
a piston (12) that can perform an axial reciprocating movement housed inside this cylinder, this piston including a head and an arm hinged to this head,
at least one intake valve (19), and
one exhaust valve (20) provided on the cylinder (11) above the piston (12), the method using gaseous dihydrogen and comprising the steps of:
a) during a first step, feeding a predetermined volume of gaseous dihydrogen and a predetermined volume of a gaseous mix containing oxygen into a space of the cylinder (11) located above the head of the piston (12);
b) during a second step, causing the mix of gaseous dihydrogen and oxygen fed into the cylinder (11) to explode at the moment when the piston (12) passes a top dead center (TDC);
c) during a third step, injecting a predetermined volume of water from the tank (23) into the cylinder (11), into a space located above the piston (12), and instantaneously vaporizing this water under the influence of the heat produced by the explosion of the mix of gaseous dihydrogen and oxygen for cooling down the engine; and
d) during a fourth step, exhausting the steam produced by the evaporation of the injected water and the combustion of the gaseous dihydrogen,
the first, second and third steps occur while the piston (12) passes from the top dead center (TDC) to a bottom dead center (BDC) while the fourth step occurs as the piston (12) passes from the bottom dead center (BDC) to the top dead center (TDC).

16. The method according to claim 15, further comprising the step of including a preliminary step during which, by electrolysis of a determined volume of water of the tank (23), gaseous dihydrogen is produced, of which at least a predetermined volume is taken during the first step.

17. The method according to claim 16, further comprising the step of performing the electrolysis of the water of the tank (23) according to a high-temperature electrolysis process.

18. The method according to claim 16, further comprising the step of using salt water during the preliminary step to produce gaseous dihydrogen by electrolysis.

19. The method according to claim 15, further comprising the step of implemented the method with an engine (10) having several cylinders (11), each including a piston (12) housed in one of the cylinders, wherein the first, second, third and fourth steps are performed individually in each of the cylinders (11) of the engine (10), each of the steps performed in one of the cylinders (11) being shifted in time with respect to the corresponding step performed in another of the cylinders (11) of the engine (10).

20. A reciprocating internal combustion engine (10) comprising:
a water tank (23),
at least one cylinder (11),
a piston (12) that can perform an axial reciprocating movement housed inside this cylinder, the piston including a head and an arm hinged to this head,
at least one intake valve (19), and
at least one exhaust valve (20) provided on the cylinder above the piston, wherein the reciprocating internal combustion engine (10) includes:
means (19, 21a) for feeding, during a first step, a predetermined volume of gaseous dihydrogen and a predetermined volume of a gaseous mix containing oxygen into the cylinder (11) into a space located above the head of the piston (12),
means (22) for producing, during a second step, explosion of the mix of gaseous dihydrogen and oxygen fed into the cylinder (11) at the moment when the piston (12) passes a top dead center (TDC),
means (21b) for injecting, during at least one third step, a predetermined volume of water from the tank (23) into the cylinder (11), into a space located above the piston (12), to instantaneously vaporize this water under influence of heat produced by the explosion of the gaseous dihydrogen and the oxygen for cooling the engine, and
means (20) for exhausting, during a fourth step, the steam produced by the evaporation of the injected water and the combustion of the gaseous dihydrogen.

21. The reciprocating internal combustion engine according to claim 20, wherein the reciprocating internal combustion engine (10) further comprises means (27) for producing gaseous dihydrogen through the electrolysis of the water contained in the tank (23).

22. The reciprocating internal combustion engine according to claim 21, wherein the water tank (23) contains salt water for producing gaseous dihydrogen by electrolysis.

23. The reciprocating internal combustion engine according to claim 21, wherein the means for producing the gaseous dihydrogen is a means for performing high-temperature electrolysis.

24. The reciprocating internal combustion engine according to claim 20, wherein the means for feeding, during a first step, a predetermined volume of gaseous dihydrogen comprises an injector (21a).

25. The reciprocating internal combustion engine according to claim 20, wherein the means for feeding, during a first step, a predetermined volume of a gaseous mix containing oxygen, comprises an intake valve (19) associated with an intake piping (19a).

26. The reciprocating internal combustion engine according to claim 20, wherein the means for injecting a predetermined volume of water into the cylinder (11) comprises an injector (21b) connected via an injection pump (30) with the water tank (23).

27. The reciprocating internal combustion engine according to claim 20, this engine has several cylinders (11) which each comprises a piston (12) housed in a respective cylinder, wherein the reciprocating internal combustion engine (10) further includes control means so that, in each of the cylinders (11), the steps corresponding to one of the cylinders are shifted in time with respect to the corresponding steps in each of the other cylinders.
